(19) United States
(12) Patent Application Publication
(10) Pub. No.: US 2024/0088423 A1
(43) Pub. Date: Mar. 14, 2024

(54) FUEL CELL DEVICE

(71) Applicant: National Taipei University of Technology, Taipei (TW)

(72) Inventors: Kuohsiu David Huang, Taipei (TW); Wen-Huang Liao, Taipei (TW)

(73) Assignee: National Taipei University of Technology, Taipei (TW)

(21) Appl. No.: 18/164,638

(22) Filed: Feb. 6, 2023

(30) Foreign Application Priority Data
Sep. 14, 2022 (TW) 111134804

(51) Int. Cl. H01M 8/2465; H01M 8/2404

(52) U.S. Cl. CPC H01M 8/2465; H01M 8/2404

(57) ABSTRACT

A fuel cell device includes a top board, a scattering board, a bottom board, and electrode modules. The top board includes a fuel entry hole, air access holes, and a fuel splitting part. The scattering board includes top air holes, bottom air holes, and slotted holes. The fuel splitting part splits a fuel to different slotted holes. The bottom board includes first slots. The electrode modules are detachably inserted in the first slots. An air space is provided in each of the electrode modules, and a fuel space is formed between any two adjacent electrode modules. The fuel entry hole, the fuel splitting part, the slotted holes, and the fuel space communicate to form a fuel channel. The air access holes, the top air holes, the bottom air holes, and the air space communicate to form an air channel, and the air channel is airtight to the fuel channel.

### CROSS-REFERENCE TO RELATED APPLICATION

This application claims the priority benefit of Taiwan application serial no. 111134804, filed on Sep. 14, 2022. The entirety of the above-mentioned patent application is hereby incorporated by reference herein and made a part of this specification.

### TECHNICAL FIELD

The disclosure relates to a cell device, and particularly relates to a fuel cell device.

### DESCRIPTION OF RELATED ART

Metal fuel flow cell has the advantages of secondary cell, flow cell, and fuel cell at the same time. With regenerative restoration, it is possible to store large amounts of energy at low cost to meet the needs of the current energy storage market. Metal-filled fuels play an energy-generating role and are suitable for applications such as independent power sources and backup power sources.

However, the existing metal fuel flow cells have the following disadvantages. The electrode is a consumable, but it is inconvenient to replace the electrode. The size of the system is relatively large, and if it cannot be further reduced, the scope of its application is significantly limited.

### SUMMARY

The disclosure provides a fuel cell device with easily replaceable electrodes and substantially reduced system size.

An embodiment of the disclosure provides a fuel cell device including a top board, a scattering board, a bottom board, and multiple electrode modules. The top board includes a fuel entry hole, multiple air access holes, and a fuel splitting part. The fuel entry hole is configured to allow a fuel to enter the fuel cell device. The air access holes are configured to allow air to flow in or out. The scattering board includes multiple top air holes, multiple bottom air holes, and multiple slotted holes. The top air holes and the bottom air holes are respectively disposed on opposite sides of the scattering board. The slotted holes are separately disposed on the top air holes and the bottom air holes. The fuel splitting part is configured to split the fuel to different slotted holes. The bottom board includes multiple first slots. The scattering board is located between the bottom board and the top board, and an accommodating space is formed by the bottom board and the scattering board. The electrode modules are disposed in the accommodating space and detachably inserted in the first slots. There is an air space in each of the electrode modules, and a fuel space is formed between any two adjacent electrode modules. The fuel entry hole, the fuel splitting part, the slotted holes, and the fuel space form a fuel channel. The air access holes, the top air holes, the bottom air holes, and the air space form an air channel, and the air channel is airtight to the fuel channel.

Based on the above, in the in the fuel cell device of an embodiment of the disclosure, the fuel entry hole, the fuel splitting part, the slotted holes, and the fuel space form a fuel channel, and the air access holes, the top air holes, the bottom air holes, and the air space form an air channel. The air channel is airtight to the fuel channel, such a design significantly reducing the size of the system. In addition, the electrode modules are detachably inserted in the first slots, which make the replacement of the electrode module easy.

### BRIEF DESCRIPTION OF THE DRAWINGS

FIG. 1 is a schematic view of a fuel cell device according to an embodiment of the disclosure.

FIG. 2 is an exploded view of a fuel cell device according to an embodiment of the disclosure.

FIG. 3 is a bottom view of the top board in FIG. 2.

FIG. 4 is a bottom view of the scattering board in FIG. 2.

FIG. 5 is a cross-sectional view of FIG. 1.

FIG. 6 is a schematic view of a cell module of a fuel cell device according to an embodiment of the disclosure.

FIG. 7 is a schematic view of a fuel space formed by a cell module of a fuel cell device according to an embodiment of the disclosure.

### DESCRIPTION OF THE EMBODIMENTS

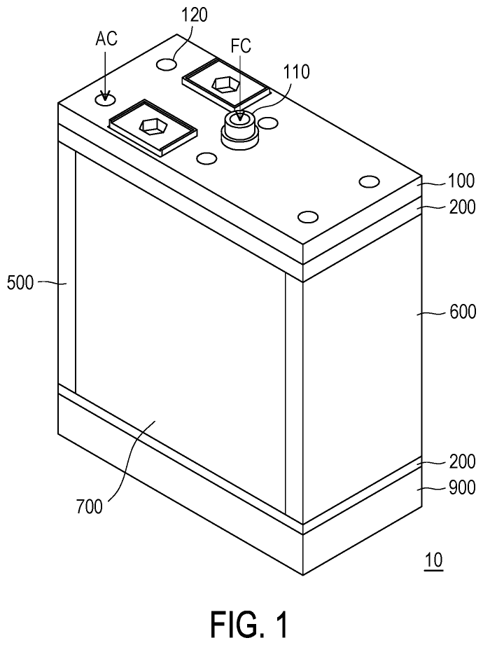

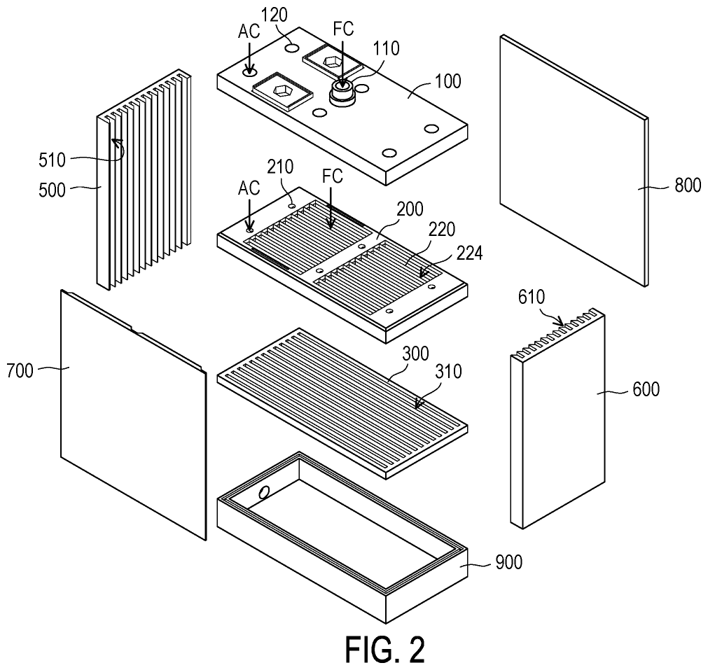

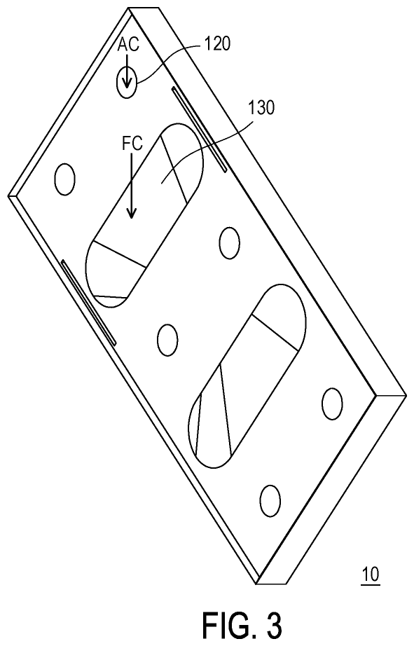

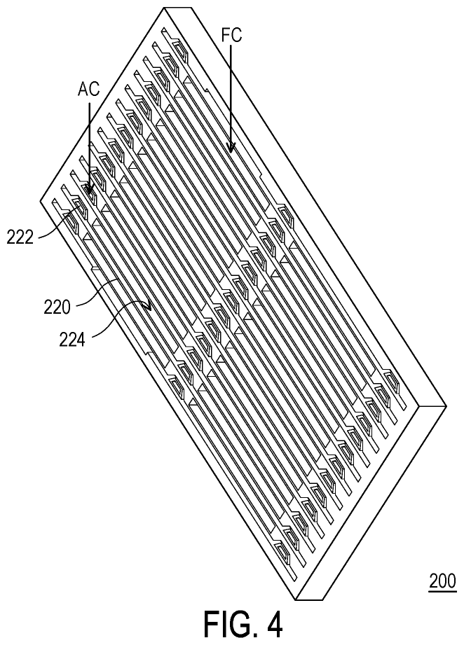

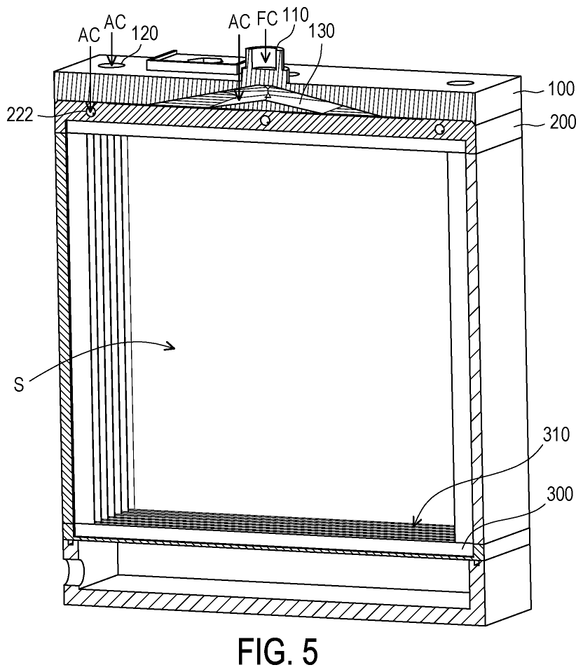

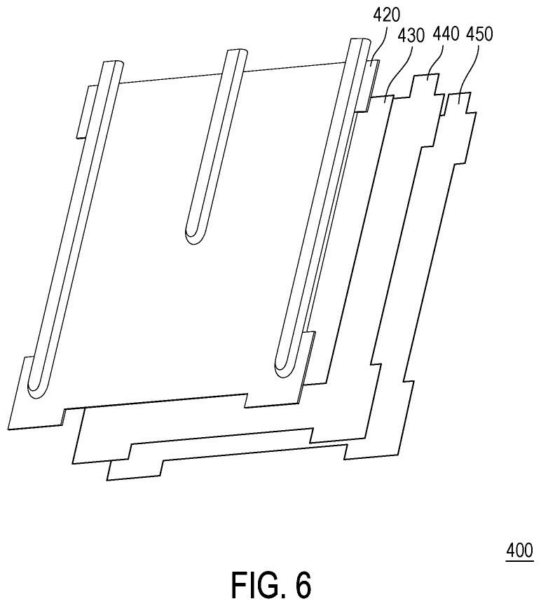

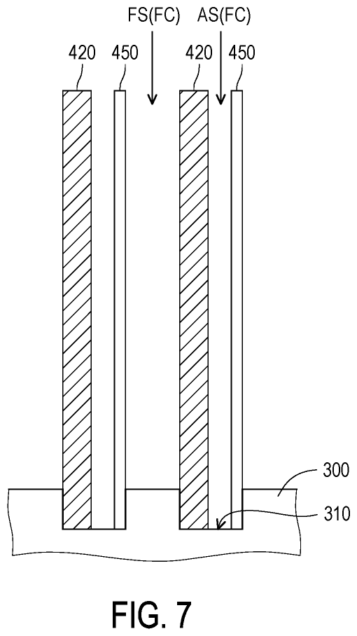

FIG. 1 is a schematic view of a fuel cell device according to an embodiment of the disclosure. FIG. 2 is an exploded view of a fuel cell device according to an embodiment of the disclosure. FIG. 3 is a bottom view of the top board in FIG. 2. FIG. 4 is a bottom view of the scattering board in FIG. 2. FIG. 5 is a cross-sectional view of FIG. 1. FIG. 6 is a schematic view of a cell module of the fuel cell device according to an embodiment of the disclosure. FIG. 7 is a schematic view of a fuel space formed by the cell module of the fuel cell device according to an embodiment of the disclosure. Please refer to FIG. 1 to FIG. 7. An embodiment of the disclosure provides a fuel cell device 10 including a top board 100, a scattering board 200, a bottom board 300, and multiple electrode modules 400.

In this embodiment, the top board 100 includes a fuel entry hole 110, multiple air access holes 120, and a fuel splitting part 130. The fuel entry hole 110 is configured to allow the fuel to enter the fuel cell device 10 and communicates with the fuel splitting part 130. The air access holes 120 and the fuel entry hole 110 are separately disposed and configured to allow air to flow in or out. For example, the two air access holes 120 located in the middle of the top board 100 of FIG. 2 are designed to allow air to flow in, and the remaining four air access holes 120 are designed to allow air to flow out. However, the disclosure does not limit the number of the air access holes 120 and the design of the positions of the air inlet and outlet. The aforementioned fuel is, for example, an electrolyte solution mixed with metal particles, and the metal is, for example, zinc (Zn), magnesium (Mg), aluminum (Al), etc.

In this embodiment, the scattering board 200 includes multiple top air holes 210, multiple bottom air holes 222, and multiple slotted holes 224. The top air holes 210 and the bottom air holes 222 are respectively disposed on opposite sides of the scattering board 200. The slotted holes 224 are separately disposed on the top air holes 210 and the bottom air holes 222. The bottom air holes 222 communicate with the air access holes 120 through the top air holes 210. The slotted holes 224 communicates with the fuel entry hole 110 through the fuel splitting part 130. The fuel splitting part 130 is configured to split a fuel to different slotted holes 224.

In this embodiment, the scattering board 200 further includes multiple levers 220. The bottom air holes 222 are disposed in the levers 220. The levers 220 are disposed in an array, and gaps between the levers 220 form the slotted holes 224.

In this embodiment, the top air holes 210 are arranged in a matrix, the slotted holes 224 are arranged in a matrix, and the bottom air holes 222 are also arranged in a matrix. The rows in the matrix formed by the top air holes 210 and the rows in the matrix formed by the slotted holes 224 are arranged in a staggered arrangement. The rows in the matrix formed by the bottom air holes 222 and the rows in the matrix formed by the slotted holes 224 are arranged in a staggered arrangement. For example, as shown in FIG. 2, the top air holes 210 are arranged in a 2×3 matrix, and the slotted holes 224 are arranged in a 12×2 matrix. In addition, as shown in FIG. 4, the bottom air holes 222 are arranged in a 13×3 matrix. However, the disclosure does not limit the number and arrangement of the top air holes 210, the slotted holes 224, and the bottom air holes 222. In addition, the fuel splitting part 130 are two inclined surfaces, and the two inclined surfaces are symmetrical to each other with respect to the arrangement of the slotted holes 224. The fuel enters from the fuel entry hole 110 and is split by the fuel splitting part 130, so that a part of the fuel flows into one row of the slotted holes 224 and the other part of the fuel flows into the other row of the slotted holes 224.

In this embodiment, bottom board 300 includes multiple first slots 310. The scattering board 200 is located between the bottom board 300 and the top board 100, and an accommodating space S is formed by the bottom board 300 and the scattering board 200. The electrode modules 400 are disposed in the accommodating space S and detachably inserted in the first slots 310. FIG. 2 shows 13 first slots 310, so that 13 electrode modules 400 may be inserted on the bottom board 300. The aforementioned 13 electrode modules 400 may be respectively designed to be in a staggered arrangement in the form of anode, cathode, . . . , anode, or designed to be in a staggered arrangement in the form of cathode, anode, . . . , anode. However, the disclosure does not limit the number of the first slots 310 and the electrode modules 400.

In this embodiment, there is an air space AS in each of the electrode modules 400, and a fuel space FS is formed between any two adjacent electrode modules 400. The air space AS communicates with the top air holes 210 through the bottom air holes 222. The fuel space FS communicates with the fuel splitting part 130 through the slotted holes 224. The fuel entry hole 110, the fuel splitting part 130, the slotted holes 224, and the fuel space FS form a fuel channel FC. The air access holes 120, the top air holes 210, the bottom air holes 222, and the air space AS form an air channel AC, and the air channel AC is airtight to the fuel channel FC.

In this embodiment, each of the electrode modules 400 includes an electrode board 420 and a separator 450. The air space AS is formed between the electrode board 420 and the separator 450, and the fuel space FS is formed between the separator 450 and the electrode board 420 of an adjacent electrode module 400. The material of the electrode board 420 is, for example, a stainless-steel sheet. The separator 450 is configured to stop the fuel from entering the air space AS inside the electrode module 400, while air passes through the separator 450 and enters the fuel space FS to oxidize the metal in the fuel and release electrons at the same time.

In this embodiment, each of the electrode modules 400 includes an intermediate layer and an intermediate layer 440. The electrode board 420, the intermediate layer 430, the intermediate layer 440, and the separator 450 are sequentially stacked. The material of the intermediate layer 430 is, for example, Polytetrafluoroethylene/PTFE. The material of the intermediate layer 440 is, for example, a mixture of nickel foam and activated carbon.

In this embodiment, the fuel cell device 10 further includes a first side board 500, a second side board 600, a third side board 700, and a fourth side board 800. The first side board 500 is opposite to the second side board 600, and the first side board 500 is connected to the scattering board 200, the bottom board 300, the third side plate 700, and the fourth side board 800. The second side board 600 is connected to the scattering board 200, the bottom board 300, the third side plate 700, and the fourth side board 800. The third side plate 700 is opposite to the fourth side board 800. The first side board 500 includes multiple second slots 510, and the second side board 600 includes multiple third slots 610. The numbers of the second slots 510, the third slots 610, and the first slots 310 are equal. The accommodating space S is formed by the bottom board 300, the first side board 500, the second side board 600, the third side plate 700, the fourth side board 800, and the scattering board 200. The electrode modules 400 are detachably inserted in the first slots 310, the second slots 510, and the third slots 610.

In this embodiment, the fuel cell device 10 further includes a recovering slot 900. The bottom board 300 is located between the scattering board 200 and the recovering slot 900. The fuel that produces an oxidation reaction in the fuel space FS may flow into the recovering slot 900 through the bottom board 300.

To sum up, in an embodiment of the disclosure, the fuel cell device is designed to include: a fuel entry hole, a fuel splitting part, slotted holes, and a fuel channel formed by a fuel space, as well as air access holes, top air holes, bottom air holes, and an air channel formed by an air space. The air channel is airtight to the fuel channel. Therefore, such a design significantly reducing the size of the system. The modular design of the electrode allows it to be detachably inserted in the first slots, which makes the replacement of the electrode module easy. Moreover, compared with the conventional metal air cells, which have problems such as inconvenience in replacing the fuel and not being able to replace the electrodes, the fuel cell device in the disclosure not only contributes to the aforementioned problems, but also improves the battery life and further makes the battery an energy storage battery.

What is claimed is:

1. A fuel cell device, comprising:
a top board, comprising a fuel entry hole, a plurality of air access holes, and a fuel splitting part, wherein the fuel entry hole is configured to allow a fuel to enter the fuel cell device, and the air access holes are configured to allow air to flow in or out;
a scattering board, comprising a plurality of top air holes, a plurality of bottom air holes, and a plurality of slotted holes, wherein the top air holes and the bottom air holes are respectively disposed on opposite sides of the scattering board, the slotted holes are separately disposed on the top air holes and the bottom air holes, and the fuel splitting part is configured to split the fuel to different slotted holes;
a bottom board, comprising a plurality of first slots, wherein the scattering board is located between the bottom board and the top board, and an accommodating space is formed by the bottom board and the scattering board; and
a plurality of electrode modules, disposed in the accommodating space and detachably inserted in the first slots, wherein an air space is provided in each of the electrode modules, and a fuel space is formed between any two adjacent electrode modules,
wherein the fuel entry hole, the fuel splitting part, the slotted holes, and the fuel space form a fuel channel,
the air access holes, the top air holes, the bottom air holes, and the air space form an air channel, and the air channel is airtight to the fuel channel.

2. The fuel cell device according to claim 1, wherein the scattering board further comprises a plurality of levers, the bottom air holes are disposed in the levers, the levers are arranged in an array, and gaps between the levers form the slotted holes.

3. The fuel cell device according to claim 1, wherein the top air holes are arranged in a matrix, and the slotted holes are arranged in a matrix,
wherein a plurality of rows in the matrix formed by the top air holes and a plurality of rows in the matrix formed by the slotted holes are arranged in a staggered arrangement.

4. The fuel cell device according to claim 1, wherein the bottom air holes are arranged in a matrix, and the slotted holes are arranged in a matrix,
wherein a plurality of rows in the matrix formed by the bottom air holes and a plurality of rows in the matrix formed by the slotted holes are arranged in a staggered arrangement.

5. The fuel cell device according to claim 1, wherein each of the electrode modules comprises:
an electrode board; and
a separator,
wherein the air space is formed between the electrode board and the separator, and the fuel space is formed between the separator and the electrode board of an adjacent electrode module.

6. The fuel cell device according to claim 1, further comprising:
a first side board, comprising a plurality of second slots, wherein the electrode modules are detachably inserted in the second slots; and
a second side board, comprising a plurality of third slots, wherein the electrode modules are detachably inserted in the third slots,
wherein the accommodating space is formed by the bottom board, the first side board, the second side board, and the scattering board.
